(19) United States
(12) Patent Application Publication
(10) Pub. No.: US 2002/0077839 A1
(43) Pub. Date: Jun. 20, 2002

(54) Method and apparatus for facilitating development of an on-line personal community of individuals

(75) Inventors: Brian M. Siegel, Washingtonville, NY (US); Philip Michael Abram, Warwick, NY (US); Marc Beckwitt, San Clemente, CA (US); Gregory D. Gudorf, San Diego, CA (US); Kazuaki Iso, Oradell, NJ (US); Brian Raymond, San Diego, CA (US)

Correspondence Address: Stuart H. Mayer, Esq., Mayer, Fortkort & Williams, L.L.C., Suite 250, 200 Executive Drive, West Orange, NJ, 07052, US

(73) Assignee: Sony Corporation/Sony Electronics Inc.

(21) Appl. No.: 09/741,733

(22) Filed: Dec. 20, 2000

(51) Int. Cl. G06F 17/60

(52) U.S. Cl. 705/1; 705/10

(57) ABSTRACT

A method and apparatus is provided for managing communications between an end user seeking to communicate over an open network with at least one member meeting a prescribed set of criteria established by the end user. The end user and the member are registered members of a common service. The method begins by receiving over the open network an end user request generated by the end user. The end user request includes the prescribed set of criteria. Next, a profile of characteristics of a plurality of members are stored in a database. Each profile is associated with an address corresponding to a particular member. The database is searched to generate a search result containing at least one candidate member with characteristics which correspond to the end user request. Finally, an electronic address is transmitted to the end user or the candidate member so that the end user or candidate member can initiate online communication with the other.

### FIELD OF THE INVENTION

The present invention relates generally to a method and apparatus for managing on-line communications among individuals subscribing to a common online service.

### BACKGROUND OF THE INVENTION

Computer-based bulletin boards and forums are known in the prior art. In a typical bulletin board system, various users access a central computer through remote connections, usually by connecting personal computers to the central computer, by telephone and modem. The users can then transmit messages to the central computer, the messages being stored in a memory which others users can access. Thus, each user can “post” messages to the bulletin board, and can “read” messages posted by other users.

Bulletin boards and forums are usually directed to predefined topics. While the users accessing a bulletin board or forum presumably are interested in its predefined topic, users are often anonymous in that when a user begins a dialogue with another user he or she knows nothing about that user. Any knowledge one user has about another is only acquired after communication has been established between the users. Accordingly, if a user wishes to communicate with other users who have particular knowledge or expertise, the process of locating such users can become quite a time consuming process of trial and error.

Computer-based bulletin boards can also serve as electronic exchanges that are designed to facilitate transactions rather than dialogues among users. One such type of exchange is referred to as an “information marketplace,” one example of which is the American Information Exchange (AMIX).

The AMIX service was designed to establish an on-line marketplace for the buying and selling of both information and consulting services where every user could be either a buyer or a seller, with AMIX facilitating transactions between them. The AMIX system required both buyers and sellers to become a member of the service, agree to pay a monthly service fee and then purchase and install a dedicated front-end program. A self-described “electronic farmer's market,” parties could negotiate agreements for the sale of information or consulting services which AMIX organized by topic. The system serves as a central record keeper and funds transfer point, either for the clearing of credit card charges or disbursements from pre-established accounts which AMIX manage. Furthermore, it encourages both buyers and sellers to post comments about each other so that future buyers and sellers are able to evaluate the past reputations of one another.

Another on-line information marketplace is disclosed in U.S. Pat. No. 5,862,223. This service allows an expert seeking to sell his services to find a client, allows the client to certify and authenticate the expert's qualifications, and allows the client to hire the expert under specific terms and conditions for a specific assignment. In one case an end user who requires information from an expert accesses an on-line exchange located at a remote server. The exchange verifies the user's identification and account status and allows the user to produce a job request suitable for consideration by an expert. The job request includes a full description of the job to be performed, a range of money the user is willing to spend, how quickly he needs the answer, and any other information necessary to respond to the request. The user can also select from menus such as subject, price, and time-to-complete menus. The user attaches the text of the letter and e-mails the job request to the exchange, which begins the process of locating a qualified expert in its database. If, after reviewing the job request, an expert is willing to do the job, he submits a formal offer of service. When a job is complete, the expert notifies the exchange and requests payment. The exchange employs a billing and payment processor to ensure that a prearranged method of payment is properly executed at the completion of the transaction.

The previously mentioned exchange services are designed to facilitate discrete transactions between an end user such as an ordinary consumer and individuals or organizations providing products, professional services, or the like. On the other hand, while bulletin boards offer a forum for more ongoing dialogs, they do not provide a mechanism that allows users to pre-select with whom they wish to communicate.

Accordingly, there is a need for an on-line service that allows users to pre-select the members of the online service with whom they will communicate based on their characteristics, interests, qualifications or other factors.

### SUMMARY OF THE INVENTION

The present invention provides a method and apparatus for managing communications between an end user seeking to communicate over an open network with at least one member meeting a prescribed set of criteria established by the end user. The end user and the member are registered members of a common service. The method begins by receiving over the open network an end user request generated by the end user. The end user request includes the prescribed set of criteria. Next, a profile of characteristics of a plurality of members are stored in a database. Each profile is associated with an address corresponding to a particular member. The database is searched to generate a search result containing at least one candidate member with characteristics which correspond to the end user request. Finally, an electronic address is transmitted to the end user or the candidate member so that the end user or candidate member can initiate online communication with the other.

In accordance with one aspect of the invention, the member profile includes an area of interest of the respective member and/or an area of expertise of the respective member.

In accordance with another aspect of the invention, the member profile includes at least one member selection selected from predefined categories. In some cases the predefined categories may be selected from the group consisting of member activities, hobbies, demographics, subjects studied, and professional affiliations.

In accordance with another aspect of the invention, the end user request includes an identifier identifying the end user. The identifier points to a member profile of the end user.

In accordance with yet another aspect of the invention, the prescribed set of criteria are selected from a list of predefined categories.

In accordance with another aspect of the invention, the end user request includes a ranking of items selected from the predefined categories.

In accordance with another aspect of the invention, preferences specified by the candidate member are retrieved from the database and any candidate member specifying a preference not met by the end user is eliminated from the search result.

In accordance with yet another aspect of the invention, the search result includes a plurality of candidate members ranked in an order based on their respective conformance to the prescribed set of criteria.

In accordance with another aspect of the invention, a notification of acceptance is received from the candidate member prior to performing the transmitting step.

In accordance with another aspect of the invention, notifications of acceptance are received from a plurality of candidate members and the electronic address of the candidate member from whom the first notification was first received is transmitted to the end user.

### BRIEF DESCRIPTION OF THE DRAWINGS

FIG. 1 shows the overall system architecture for practicing the present invention.

FIG. 2 shows a block diagram of the central controller depicted in FIG. 1.

FIG. 3 shows an illustrative member interface device that may be employed in connection with the present invention.

FIG. 4 is an architectural block diagram of the end user interface device illustrated in FIG. 2.

FIG. 5 is a flowchart depicting how an end user request is generated and transmitted to the central controller.

FIG. 6 is a flowchart depicting how the central controller processes the end user request to obtain a list of candidate members and facilitates communication between the end user and the candidate members.

### DETAILED DESCRIPTION

At this point it is worth noting that any reference herein to “one embodiment” or “an embodiment” means that a particular feature, structure, or characteristic described in connection with the embodiment is included in at least one embodiment of the invention. The appearances of the phrase “in one embodiment” in various places herein are not necessarily all referring to the same embodiment.

The present invention provides a method and apparatus allowing individuals to register as members with an on-line service so that they can communicate with other registered members of the service. The service maintains a profile of each member, which specifies characteristics, interests, and expertise of the respective members. By searching the member profiles, members can seek out other members with similar interests, concerns, specialized knowledge, or with particular likes and dislikes. For example, a member can solicit advice from other members on a particular product, such as an automobile, for example, whereby the solicited members are those who like Fords but not GM automobiles. Alternatively, a member might be interested in discussing the fine arts with someone who has at least a college degree in fine art and likes works from the Italian Renaissance but not works of the French Impressionists. Accordingly, over time, as the number of interactions among members grows, each member develops a self-defined community of members with similar interests. After discussing an exemplary system architecture for carrying out the present invention, various implementations will be presented to further illustrate the present invention.

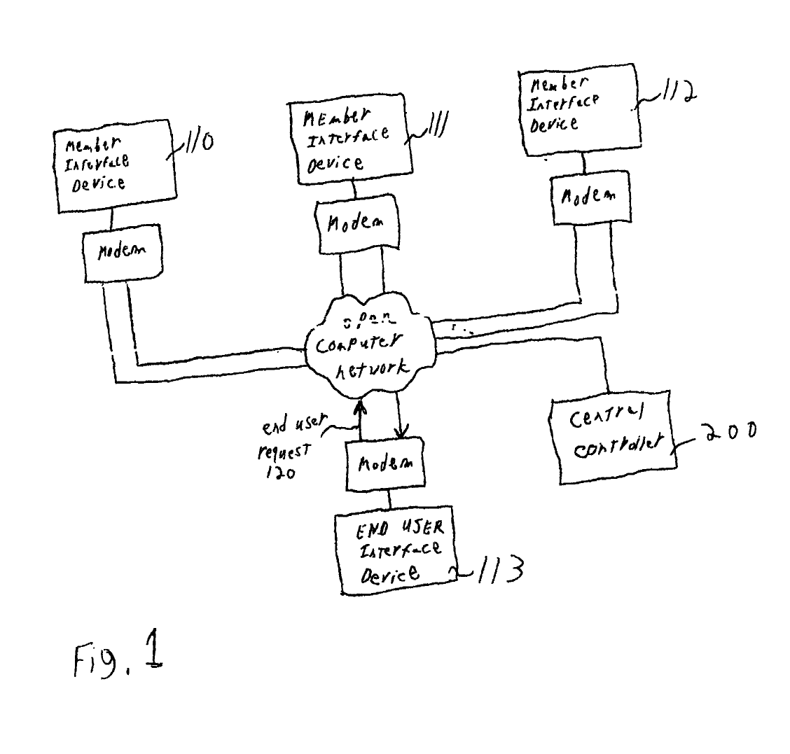

The system architecture of one embodiment of the apparatus and method of the present invention is illustrated with reference to FIGS. 1-4. As shown in FIG. 1, the apparatus of the present invention comprises member interface devices 110-113 and central controller 200 (collectively the “nodes”). Each node is connected via an open computer network, e.g., the Internet, using, for example, a public switched phone network 115, such as those provided by a local or regional telephone operating company. Connection may also be provided by dedicated data lines, cellular, Personal Communication Systems (“PCS”), microwave, or satellite networks. Interface devices 110-113 are the input and output gateways by which members communicate with central controller 200.

Using the above components, the present invention provides a method and apparatus for an end user to communicate with one or more members based on criteria established by the end user. As used herein, the term end user refers to a particular one of the members who wants to establish communication with one or more other members based on a set of criteria. In FIG. 1, member interface device 113 is illustrated as the end user. That is, an end user is a member of the inventive service. Through the method and apparatus of the present invention, end users can efficiently specify criteria to select other members with which they wish to communicate on a given topic or topics

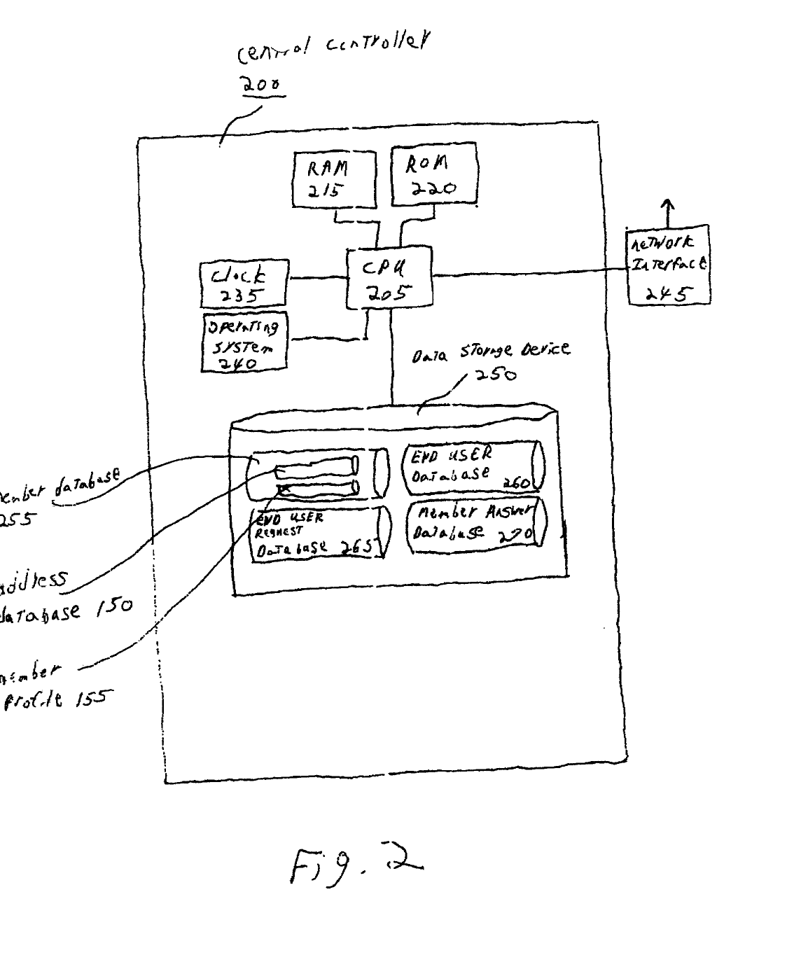

As shown in FIG. 2, central controller 200 includes central processor (CPU) 205, RAM 215, ROM 220, clock 235, operating system 240, network interface 245, and data storage device 250. Central controller 200 may be a conventional personal computer or computer workstation with sufficient memory and processing capability. In one embodiment of the invention central controller 200 operates as a web server, both receiving and transmitting data inquiries generated by end users. Central controller 200 must be capable of high volume transaction processing, performing a significant number of mathematical calculations in processing communications and database searches. Illustrative processors that may be employed include a Pentium microprocessor, commonly manufactured by Intel Inc., a PowerPC available from Motorola, or an UltraSPARC processor available from Sun Microsystems.

Data storage device 250 may include hard disk magnetic or optical storage units, as well as CD-ROM drives or flash memory. Data storage device 250 contains databases used in the processing of transactions in the present invention, including member database 255, end user database 260, end user request database 265, and member answer database 270. In one embodiment of the invention database software, such as available from Oracle Corporation, is used to create and manage these databases.

Member database 255 includes address database 150 and member profile database 155. Address database 150 maintains data on the members, including their name, address, email addresses, physical addresses, and voice mail addresses. Member profile database 155 includes information of interest to other members such as their biographies and subject areas of interest and expertise. In one particular embodiment of the invention, member profile 155 includes pre-defined categories such as activities, hobbies, demographics, school subject studied, and professional affiliations. In this embodiment the members rank their interest and expertise for various items in each predefined category. Member profile 155 will be used to select members based on the criteria established by the end user.

End user request database 265 includes all end user requests received by central controller 200. A unique tracking number is also stored for each end user request. End user request database 265 also stores the selective criteria specified by the end user, which is used to select other members based on their respective member profiles.

Network interface 245 is the gateway to communicate with members through their respective member interface devices 500. Conventional internal or external modems may serve as network interface 245. Network interface 245 supports modems at a range of baud rates from 1200 upward, but may combine such inputs into a T1 or T3 line if more bandwidth is required. In one embodiment of the invention, network interface 245 is connected with the Internet and/or any of the commercial online services such as America Online, CompuServe, or Prodigy, allowing members access to the service from a wide range of online connections. Several commercial email servers include the above functionality. Users can exchange messages with enclosures such as files, graphics, video and audio.

While the above embodiment describes a single computer acting as the central controller 200, those skilled in the art will realize that the functionality can be distributed over a plurality of computers. In another embodiment, central controller 200 may be configured in a distributed architecture, wherein the databases and processors are housed in separate units or locations.

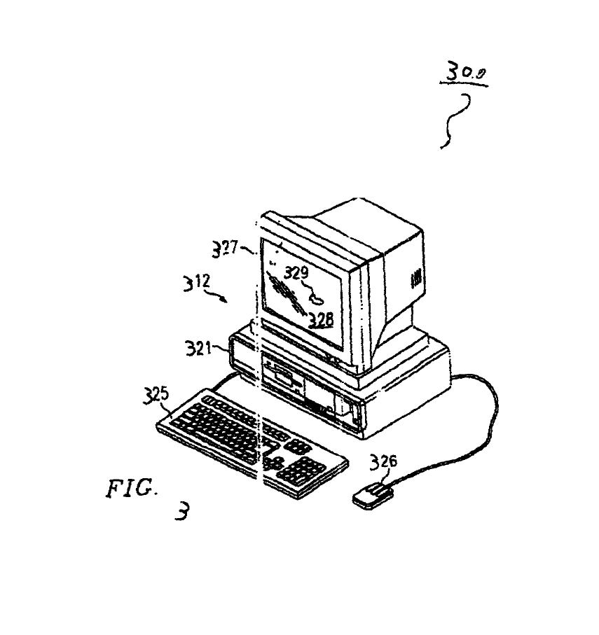

FIG. 3 shows a block diagram of an illustrative member interface device 300 that may be employed in connection with the present invention. While the device 300 is illustrated as a general purpose computer, those or ordinary skill in the art will recognize that the user interface device may be any device that can communicate with, and download information from, an open computer network such as the Internet. The device 300 includes a system unit 321, a keyboard 325, a mouse 326 and a display unit 327. The screen 328 of the display unit 327 is used to present a graphical user interface (GUI). The graphical user interface supported by the operating system of the device 300 allows the user to use a point and shoot method of input, i.e., by moving the mouse pointer 329 to an icon representing a data object at a particular location on the screen 328 and pressing on the mouse buttons to perform a user command or selection. This type of arrangement also allows the user to directly manipulate an icon from one position to another on the screen, all in a known manner.

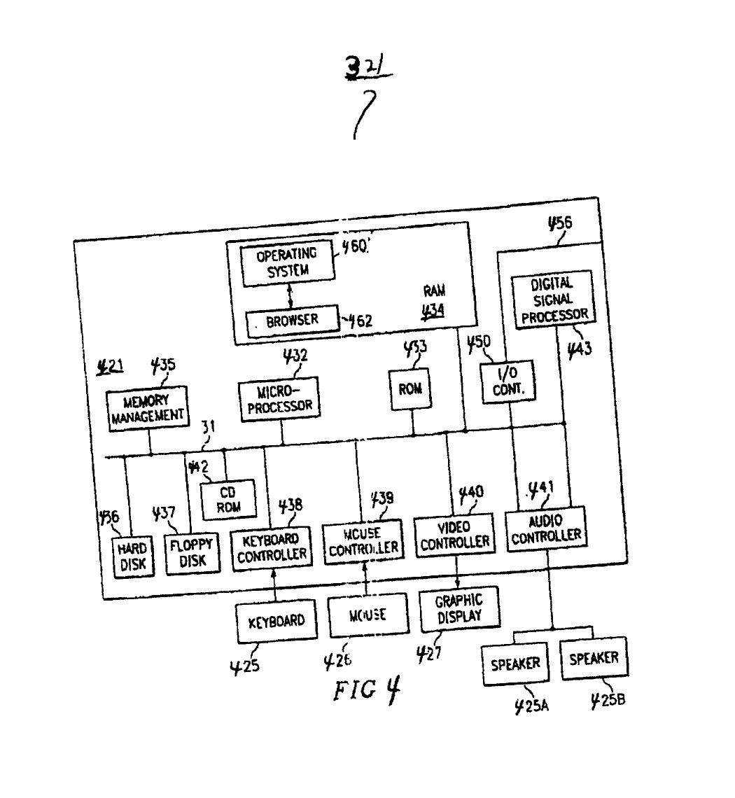

Turning to FIG. 4, the system unit 321 includes a system bus or plurality of system buses 431 to which various components are coupled and by which communication between the various components is accomplished. The microprocessor 432 is connected to the system bus 431 and is supported by read only memory (ROM) 433 and random access memory (RAM) 434 also connected to system bus 431. The ROM 433 contains among other code the Basic Input-Output system (BIOS), which controls basic hardware operations such as the interaction of the disk drives and the keyboard. The RAM 434 is the main memory into which the operating system and application programs are loaded. The memory management chip 435 is connected to the system bus 431 and controls direct memory access operations including, passing data between the RAM 434 and hard disk drive 436 and floppy disk drive 437. The CD ROM 442, also coupled to the system bus 431, is used to store a large amount of data, e.g., a multimedia program or large database. Also connected to this system bus 431 are various I/O controllers: the keyboard controller 438, the mouse controller 439, the video controller 440, and the audio controller 441. The keyboard controller 438 provides the hardware interface for the keyboard 25, the controller 439 provides the hardware interface for the mouse (or other point and click device) 426, the video controller 440 is the hardware interface for the display 427, and the audio controller 441 is the hardware interface for the multimedia speakers 425a and 425b. A network interface card (NIC) interfaces to the I/O controller 450 to enable communication via path 456 to other computers over the computer network.

The operating system 460 of the computer may be MS-DOS, WINDOWS 3.x, WINDOWS 95, WINDOWS NT, OS/2, AIX, or any other known and available operating system. RAM 434 also supports a number of Internet access tools including, for example, an HTTP-compliant web browser 462. Known browser software includes Netscape Navigator, Microsoft Internet Explorer, mosaic, and the like. RAM 434 may also support other Internet services including simple mail transfer protocol (SMTP) or e-mail, file transfer protocol (FTP), network news transfer protocol (NNTP) or “Usenet”, and remote terminal access (Telnet).

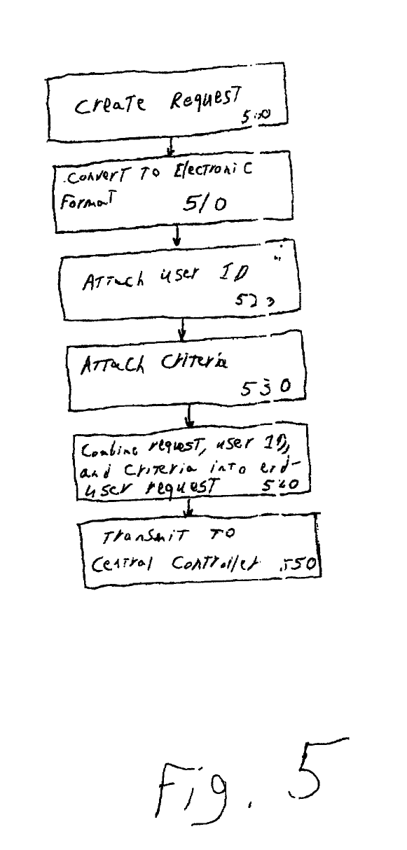

With reference to FIG. 5, there is described an exemplary process by which the end user formulates end user request 120 (see FIG. 1). The end user first creates a request 115 at step 500, such as a question or an issue for discussion which requires human judgment, evaluation, analysis, or the like. A student, for example, might want to recruit a teacher for guidance on a particular education-related topic. Multiple questions or issues may also be bundled into one request 115. At step 510, the end user converts the request into an electronic format, if necessary. Once converted, the end user attaches his name or a unique user ID number to the request at step 520. This ID number is received from central controller 200 when the end user registers for the service, or is chosen by the end user and then registered with central controller 200 by phone. Central controller 200 maintains a database of end user ID numbers in end user database 260, and issues (or allows) only unique numbers. If less security is required, the user's telephone number could serve as the ID number since it has the advantages of being both unique and easily remembered.

At step 530, the end user attaches criteria to the request. The criteria will typically describe such things as the characteristics, specialized knowledge, and likes and dislikes of the members with whom the end user wishes to communicate. As previously mentioned, the criteria may be specified in terms of a ranking in categories predefined by the inventive service. At step 540, both the user ID and the criteria are combined with request 115, producing a complete end user request 120. It should be noted that the criteria and request 115 need not be distinct items. Rather, request 115 may be subsumed as a part of the specified criteria. For example, the criteria may simply specify that the end user would like to communicate with an owner of a Ford but not a GM automobile. Finally, the end user request 120 is then transmitted to central controller 200 at step 550.

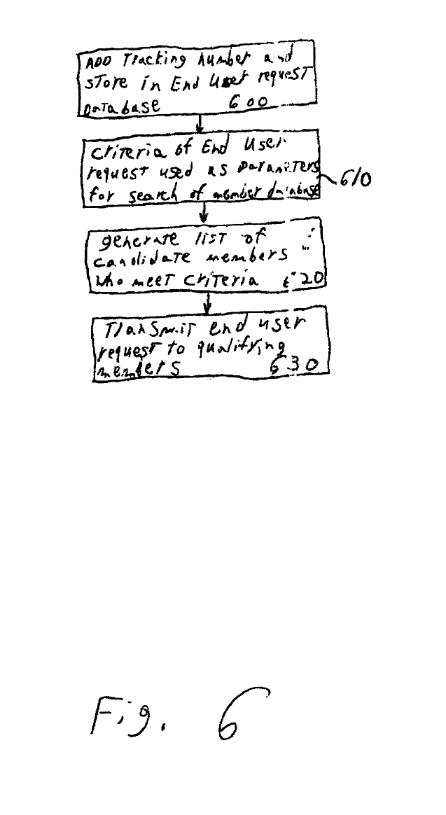

Referring to FIG. 6, the end user request 120 is received, stored, and processed by the central controller 200. More specifically, the end user request is received from the end user at step 600. Central controller 200 then begins to search for appropriate candidate members satisfying the criteria provided by the end user. At step 610, the criteria are extracted and used as parameters for a search of the member database 255. At step 620, a list of candidate members is generated who meet the criteria. In one example, if the user is a student searching for a teacher, the criteria may specify the minimum educational level and years of experience of the teacher.

The resulting list of candidate members may be reduced after the central controller 200 examines the selection criteria of the individual candidate members. That is, each candidate member may specify preferences regarding the characteristics of the end user requests to which they will respond. For example, in the case where the end user is a student searching for a teacher, a candidate member (a teacher) may specify that he only wishes to communicate with members who are of college age or older. Accordingly, if the end user were a high school student, this particular candidate member would be eliminated from the list of candidate members. At step 630, the central controller 200 transmits the end user request to the remaining qualified members. In some embodiments of the invention the qualified members may be provided with the user ID of the end user so that they can directly contact the end user. Conversely, the end user may be provided with the user ID of the qualified members so that they can be directly contacted by the end user. In other embodiments of the invention, if a qualified member wishes to respond to the end user, he sends an acceptance message to the central controller 200. The central controller 200 in turn sends the user ID of the end user to one of the members from whom an acceptance message was received. In a preferred embodiment of the invention, the central controller 200 sends the user ID to the first responding member.

After the end user completes the communication session with the member, the end user may be prompted by the central controller 200 to provide reference data such as a rating representing the perceived value or appropriateness of the response from the member. For example, the rating may indicate the degree to which the end user believes that the member's qualifications as stated in the member profile database 155 are accurate. Such ratings may be incorporated into member profile database 155 so that subsequent end users may use them in establishing criteria for selecting members with whom to communicate. For example, an end user may only wish to communicate with members in which their self-ranking in some area of expertise is equal to the ranking provided by previous end users.

Members may use the inventive service for a variety of different purposes. In this way any given member may belong to one or more self-defined communities or networks of members. For example, in one network students can use the service to solicit a tutor for an academic subject. Conversely, in the same network of members, tutors can use the service to solicit students. Another network may comprise members who live in the same geographic area. Members belonging to this network may use it for a variety of purposes such as establishing neighborhood car-pools or obtaining advice concerning local businesses, for example.

1. A method for managing communications between an end user seeking to communicate over an open network with at least one member meeting a prescribed set of criteria established by the end user, said end user and said at least one member being registered members of a common service, said method comprising the steps of:
receiving over the open network an end user request generated by the end user which includes the prescribed set of criteria;
storing in a database a profile of characteristics of a plurality of members, each profile being associated with an address corresponding to a particular member;
searching the database to generate a search result containing at least one candidate member with characteristics which correspond to the end user request; and
transmitting an electronic address to the end user or the candidate member so that the end user or candidate member can initiate online communication with the other.

2. The method of claim 1 wherein said member profile includes an area of interest of the respective member.

3. The method of claim 1 wherein said member profile includes an area of expertise of the respective member.

4. The method of claim 1 wherein said member profile includes at least one member selection selected from predefined categories.

5. The method of claim 4 wherein said predefined categories are selected from the group consisting of member activities, hobbies, demographics, subjects studied, and professional affiliations.

6. The method of claim 1 wherein said end user request includes an identifier identifying the end user.

7. The method of claim 6 wherein said identifier points to a member profile of the end user.

8. The method of claim 1 wherein said prescribed set of criteria are selected from a list of predefined categories.

9. The method of claim 8 wherein said end user request includes a ranking of items selected from the predefined categories.

10. The method of claim 1 further comprising the steps of retrieving from the database preferences specified by the candidate member and eliminating from said search result any candidate member specifying a preference not met by the end user.

11. The method of claim 1 wherein said search result includes a plurality of candidate members ranked in an order based on their respective conformance to the prescribed set of criteria.

12. The method of claim 1 further comprising the step of receiving a notification of acceptance from the candidate member prior to performing the transmitting step.

13. The method of claim 1 further comprising the steps of receiving notifications of acceptance from a plurality of candidate members and transmitting to the end user the electronic address of the candidate member from whom said notification was first received.

14. The method of claim 1 wherein said open network is the Internet.

15. The method of claim 1 further comprising the step of receiving from the end user an evaluation rating the candidate member after the end user communicates with the candidate member.

16. An on-line apparatus for managing communications between an end user seeking to communicate over an open network with at least one member meeting a prescribed set of criteria established by the end user, said end user and said at least one member being registered members of a common service, said apparatus comprising:
a controller unit for receiving over the open network an end user request generated by the end user which includes the prescribed set of criteria, the controller unit having a database for storing therein a profile of characteristics of a plurality of members, each member profile being associated with an address corresponding to a particular member;
means for searching the database to generate a search result containing at least one candidate member with characteristics which correspond to the end user request; and
means for forwarding an electronic address to the end user or the candidate member so that the end user or candidate member can initiate online communication with the other.

17. The apparatus of claim 16 wherein said member profile includes an area of interest of the respective member.

18. The apparatus of claim 16 wherein said member profile includes an area of expertise of the respective member.

19. The apparatus of claim 16 wherein said member profile includes at least one member selection selected from predefined categories.

20. The apparatus of claim 19 wherein said predefined categories are selected from the group consisting of member activities, hobbies, demographics, subjects studied, and professional affiliations.

21. The apparatus of claim 16 wherein said end user request includes an identifier identifying the end user.

22. The apparatus of claim 21 wherein said identifier points to a member profile of the end user.

23. The apparatus of claim 16 wherein said prescribed set of criteria are selected from a list of predefined categories.

24. The apparatus of claim 23 wherein said end user request includes a ranking of items selected from the predefined categories.

25. The apparatus of claim 16 further wherein said searching means includes means for retrieving from the database preferences specified by the candidate member and eliminating from said search result any candidate member specifying a preference not met by the end user.

26. The apparatus of claim 16 wherein said search result includes a plurality of candidate members ranked in an order based on their respective conformance to the prescribed set of criteria.

27. The apparatus of claim 16 wherein said open network is the Internet.

28. The apparatus of claim 16 further comprising a second database receiving and storing from the end user an evaluation rating the candidate member after the end user communicates with the candidate member.

29. A method of establishing an on-line network of members belonging to a common on-line service and having a self-defined set of interests in common, said method comprising the steps of:
transmitting over an open computer network a prescribed set of criteria to a processor communicating with a database storing a member profile of characteristics of a plurality of members; and
receiving over the open computer network an electronic address of at least one individual member who satisfies the prescribed set of criteria based on the member profile of characteristics of the individual member.

30. The method of claim 29 wherein said member profile includes an area of interest of the respective member.

31. The method of claim 29 wherein said member profile includes an area of expertise of the respective member.

32. The method of claim 29 wherein said member profile includes at least one member selection selected from predefined categories.

33. The method of claim 32 wherein said predefined categories are selected from the group consisting of member activities, hobbies, demographics, subjects studied, and professional affiliations.

34. The method of claim 29 wherein said prescribed set of criteria are selected from a list of predefined categories.

35. The method of claim 29 wherein at least one individual member eliminating from said search result any candidate member specifying a preference not met by an end user who performs the transmitting step.

36. The method of claim 29 wherein said at least one individual member includes a plurality of candidate members ranked in an order based on their respective conformance to the prescribed set of criteria.

37. The method of claim 29 wherein said open network is the Internet.

38. The method of claim 29 further comprising the step of transmitting an evaluation rating the at least one individual member after completing communication with the at least one individual member.
